(19) United States
(12) Patent Application Publication
(10) Pub. No.: US 2013/0280678 A1
(43) Pub. Date: Oct. 24, 2013

(54) AIRCREW TRAINING SYSTEM

(71) Applicant: THE BOEING COMPANY, Chicago, IL (US)

(72) Inventors: John Towers, Northgate (AU); William Cheung, Caboolture (AU)

(73) Assignee: The Boeing Company, Chicago, IL (US)

(21) Appl. No.: 13/867,149

(22) Filed: Apr. 22, 2013

(30) Foreign Application Priority Data
Apr. 23, 2012 (AU) 2012901601
Mar. 12, 2013 (AU) 2013201418

(51) Int. Cl. G09B 9/10

(52) U.S. Cl. CPC G09B 9/10
USPC 434/38

(57) ABSTRACT

An aircrew training system and method utilizes an analytical software tool to assess student pilot gaze activity and flight performance against established baseline standards. The system comprises databases that contain information detailing the expected state of aircraft instrumentation and characteristics of experienced gaze behavior associated with activities undertaken throughout each phase of flight. These databases provide operational context and a baseline reference for performance evaluation. The resultant output provides the instructor with insight into student gaze intersection, scan activity, adopted strategies, and other performance metrics based on cumulative data.

### RELATED PATENT APPLICATIONS

This application claims the benefit of foreign priority from Australian Patent Application No. 2013201418 filed on Mar. 12, 2013 and Australian Provisional Patent Application No. 2012901601 filed on Apr. 23, 2012.

### BACKGROUND

The present disclosure relates generally to aircrew training and, in particular, to real-time systems for assessing student pilot performance in flight simulators.

Student pilots are expected to adopt different strategies in response to different conditions within each phase of flight. Each strategy calls for specific patterns of visual attention when monitoring flight deck instruments during execution of the strategy. To assess this development, pilot instructors currently rely on the subjective interpretation of cues to determine the characteristics of a student's visual attention during flight simulator training exercises. For example, changes in student head orientation and physical activity indicate adjustments in visual attention, while aircraft state information also offers cues for gauging visual scanning patterns. These cues are often vague and difficult to evaluate. Adding to the uncertainty regarding the correct interpretation of such cues, students find it difficult to accurately recall specifics regarding visual attention during post training debrief sessions. This is due to the fallibility of memory, which is often compounded by the implicit and transient nature of associated reasoning.

Because of these uncertainties, instructors face an elevated workload when striving to determine and maintain awareness of student visual attention, which may degrade the effectiveness of training intervention through untimely and inaccurate guidance.

### SUMMARY

The subject matter disclosed herein is a system and a method for aircrew training configured to assist instructors with assessing student pilot gaze activity and flight performance. The system includes a gaze tracker that provides real-time data on the gaze intersection point of the student during training exercises on a flight simulator. The system also includes databases that contain reference information detailing the expected values and tolerances of aircraft instrumentation and characteristics of experienced gaze behavior associated with each phase of flight, e.g., takeoff, level flight, and landing, and procedural activities undertaken within each phase, e.g., “final approach” during the landing phase. These databases provide an operational context-dependent baseline reference for performance evaluation. The system also includes software-implemented analysis methods that analyze the student gaze intersection data and flight simulator variable data against the operational context and baseline reference information. The system also includes a storage means on which the flight simulator data, the student gaze intersection data, and the analysis results may be synchronously recorded for later playback. The system also includes one or more display devices, such as a tablet computer, on which real-time data and analysis results may be presented to the instructor.

Gaze scan traces, performance flags, and other information regarding student visual attention and adopted strategies are presented through customizable display interfaces on the computing devices. The displays provide the instructor with insight into student gaze scan behavior, adopted strategies, and other performance metrics based on cumulative data. Through the interfaces, the instructor can input time-stamped annotations into the recorded data stream by writing, typing, or drawing abstract notes, pressing preconfigured buttons, or through audio commentary.

All recorded simulator data, gaze scan data, analysis results, and instructor annotations are available for synchronous playback during post-training evaluation and student debrief.

The system thereby enhances the capacity of instructors to nurture good performance earlier in a pilot's training, while identifying and correcting poor technique that may otherwise persist undetected.

One aspect of the subject matter disclosed herein is an aircrew training system comprising: a computing device hosting a flight simulator configured to be operated by a student and to generate data indicating the current state of the flight simulator; a gaze tracker configured to generate gaze scan data indicating successive points of intersection of the visual gaze of a student on a display of the computing device; and an analysis server configured to analyze data from the flight simulator and the gaze scan data, thereby generating results indicating the performance of the student for presentation to an instructor. The analysis server is further configured to provide the analysis results to an instructor console configured to present the flight simulator data and the generated analysis results to the instructor. The analysis is dependent on the current operational context of the flight simulator. In accordance with one embodiment, the analysis server is further configured to: (a) determine the current operational context of the flight simulator from the flight simulator data and the gaze scan data; (b) retrieve experienced gaze information associated with the current operational context; (c) determine whether the gaze scan data has deviated significantly from the experienced gaze information associated with the current operational context; and (d) generate, depending on the determination, a performance flag indicating the nature of the deviation. The analysis server may be further configured to update, using the gaze scan data, a gaze scan trace indicating a portion of the recent history of successive points of intersection.

Another aspect is a method for assessing gaze activity of a flight simulator user, comprising: (a) acquiring gaze scan data during a flight simulation session, said gaze scan data indicating successive points of intersection of the visual gaze of a user on a display of the flight simulator; (b) determining the current operational context of the flight simulator; (c) retrieving experienced gaze data associated with a stored operational context associated with the current operational context; (d) determining whether or not the gaze scan data differs from the experienced gaze data by more than a threshold; and (e) generating performance assessment data representing the result of step (d). The performance assessment data is transmitted to a display device being viewed by an instructor.

A further aspect is an aircrew training system comprising: a computer system hosting a flight simulator configured to generate out-of-cockpit view video data, instrumentation view video data and variable data indicating the current state of the flight simulator; first and second display means for presenting said out-of-cockpit view video data and said instrumentation view video data; a gaze tracker configured to output gaze scan data indicating successive points of intersection of the visual gaze of a user viewing said first display means; and an analysis server configured to analyze data from said flight simulator and said gaze scan data to generate performance assessment data, following which said second display means will display textual and/or graphical indicators representing said performance assessment data overlying either out-of-cockpit view video data or instrumentation view video data.

Yet another aspect is an electronic device comprising: a communications interface configured to receive out-of-cockpit view video data, instrumentation view video data, gaze scan data, and performance deviation data; a display screen; and a computer system programmed to control the display screen to display the out-of-cockpit view video data in a first window on the display screen, display the instrumentation view video data in a second window on the display screen, display a current gaze intersection point indicator overlaid on a location within one of the first and second windows specified by the gaze scan data, and display a performance flag overlaid on one of the first and second windows which indicates the nature of a performance deviation specified by the performance deviation data. Preferably, the computer system is further programmed to control the display screen to display a graphical user interface having an event logging field, and also display a time-stamped annotation in the event logging field of the graphical user interface when the performance flag is displayed. The annotation states the nature of, i.e., characterizes, the performance deviation.

In accordance with a further aspect, the graphical user interface also has virtual buttons, in which case the computer system is further programmed to control the display screen to log a time-stamped annotation in a record stream in response to a user interaction with one of the virtual buttons.

Other aspects of the aircrew training system and method are disclosed below.

### BRIEF DESCRIPTION OF THE DRAWINGS

FIG. 1 is a block diagram representing components of an aircrew training system in accordance with one embodiment.

FIG. 2A is a block diagram representing components of a general purpose computer system which can be used to implement the computing device, data server, analysis server, and instructor console depicted in FIG. 1.

FIG. 2B is a block diagram showing in further detail the processor and aggregated memory of the computer system depicted FIG. 2A.

FIG. 3A is a block diagram representation of an electronic device which can be used to implement the tablet computing device depicted in FIG. 1.

FIG. 3B is a block diagram showing in further detail the embedded controller depicted FIG. 3A.

FIG. 4 is a flow diagram illustrating an analysis method carried out by the analysis server of FIG. 1 in accordance with one embodiment;

FIG. 5 includes two illustrative screenshots of video data presented to the instructor via the instructor console in the system of FIG. 1 using the method of FIG. 4; and

FIG. 6 is an illustrative screenshot of video data presented to the instructor via the tablet computing device in the system of FIG. 1 using the method of FIG. 4.

FIG. 7 is an illustrative screenshot of video data presented to the instructor in accordance with an alternative embodiment.

Reference will hereinafter be made to the drawings in which similar elements in different drawings bear the same reference numerals. Where reference is made in any one or more of the accompanying drawings to steps and/or features, which have the same reference numerals, those steps and/or features have, for the purposes of this description, the same function(s) or operation(s), unless the contrary intention is apparent.

### DETAILED DESCRIPTION

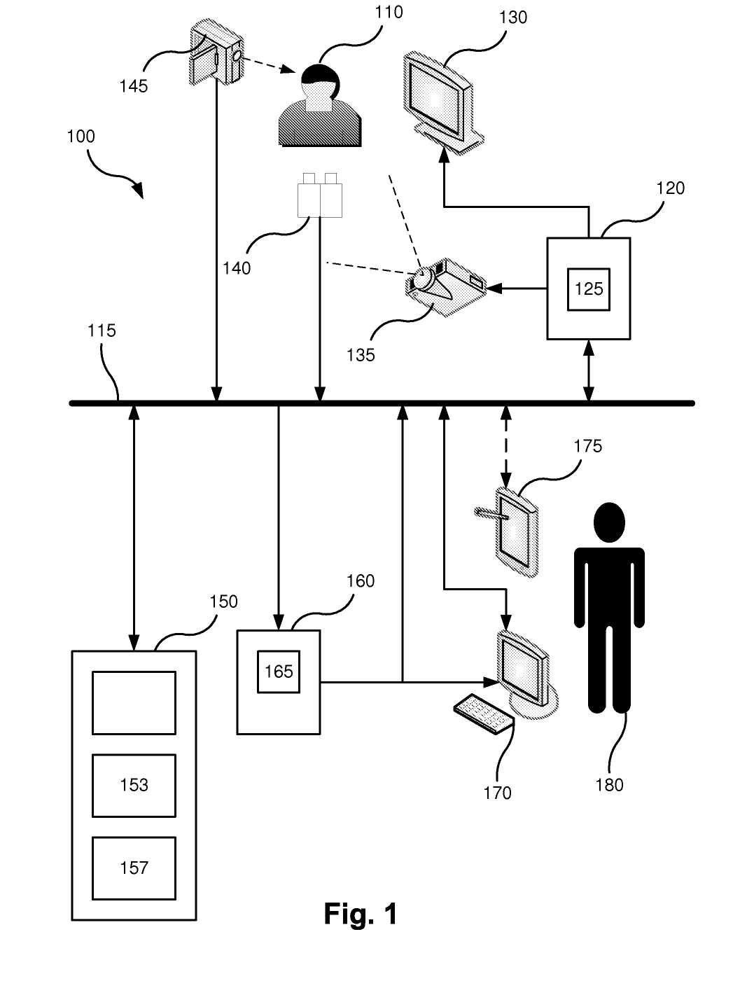

FIG. 1 is a block diagram of an aircrew training system 100 in accordance with one embodiment. The system 100 includes a computing device 120 that is configured to host a flight simulator software application 125. The flight simulator 125 is configured to simulate the behavior of a particular model of aircraft in order to train a student pilot 110. The computing device 120 is also configured to provide a user interface through which the student 110 can “operate” the simulated aircraft of the flight simulator 125 during a training exercise in conventional fashion. The flight simulator 125 generates several kinds of real-time data indicating the current state of the simulator 125.
(1) “Out-of-cockpit view” video data, showing a simulated pilot's view of the airspace and terrain over which the training exercise is being conducted. In the system 100 illustrated in FIG. 1, the “out-of-cockpit view” video is provided to a video projector 135 that projects the “out-of-cockpit view” onto a surface (not shown) that is viewable by the student 110. In other implementations, the “out of cockpit view” is provided in portions to one or more display screens, each of which shows a separate portion of the “out of cockpit view” to the student 110.
(2) “Instrumentation view” video data showing simulated flight instruments. In the system 100 illustrated in FIG. 1, the “instrumentation view” video is provided to a single display 130. In other implementations, the “instrumentation view” video is provided to multiple displays, each of which shows a separate portion of the “instrumentation view”.
(3) Audio data representing the simulated sound of the aircraft for presentation to the student 110 via a loudspeaker or headphones.
(4) Flight simulator variable data indicating aspects of the current state of the simulated aircraft and the student's operation of the simulator 125. Some of the flight simulator variables, such as airspeed, altitude, etc., are graphically represented in the instrumentation view video data. However, some of the flight simulator variables, such as yoke control parameters, are not graphically represented in the instrumentation view video data.

The VADAAR product (previously known as SimOps) from the ImmersaView company (www.immersaview.com) of Banyo, Queensland, Australia, is a commercially available system that is configurable for handling the data from the simulator 125 in the manner described below.

The system 100 also comprises a gaze tracker 140 that is configured to non-invasively track the current direction of the visual gaze of the student 110. In one implementation, the gaze tracker 140 comprises a stereo pair of cameras and an infrared light source. The stereo camera pair is configured to track the “glint” of the reflection of the infrared light from the iris contour of each eye of the student 110 and thereby generate real-time data indicating the three-dimensional angle of the student's gaze direction. One example of such a gaze tracker 140 is Facelab, available from Seeing Machines Inc. (www.seeingmachines.com) of Canberra, Australia. Once correctly calibrated to a three-dimensional CAD model of the physical environment of the simulator 125, as described below, the gaze tracker 140 generates real-time data indicating the three-dimensional point of intersection of the student's gaze. The tracker 140 also provides pixel coordinates of the student's gaze on the video data displayed by the display 130 and the projector 135. In other implementations, the system 100 comprises multiple gaze trackers 140 to increase the range of gaze direction values measurable by the system 100.

As an alternative, it will be understood that the gaze tracker may comprise a single camera. Further, it will be understood that multiple camera modules may be networked together within the gaze tracker unit, thereby extending the gaze tracking coverage throughout the flight deck.

The system 100 also includes a “scene” camera 145 that is configured to generate real-time “scene” audiovisual data including the student 110 and the computing device 120. The scene camera 145 provides an audiovisual record of the physical activity undertaken by the student 110 while interacting with the computing device 120 for relay to the computer tablet 175 and instructor console 170, as further described below.

The gaze tracker 140, the computing device 120, and the scene camera 145 are connected to a local area network 115 so as to provide their respective data feeds to other elements of the system 100. The computing device 120 is configured to provide over the network 115 real-time data from the flight simulator 125, namely, the audio data, the two kinds of video data (cockpit view and instrumentation view), and the flight simulator variable data. The scene camera 145 is configured to provide the scene audiovisual data over the network 115. The gaze tracker 140 is configured to provide calibrated gaze direction data over the network 115.

Also connected to the local area network 115 is a data server 150. The data server 150 contains a computer readable storage medium 151 and is configured to synchronously record, and synchronously play back, the data received over the network 115 from the computing device 120, the scene camera 145, and the gaze tracker 140 to or from the computer readable storage medium 151. The data server 150 also contains two databases:
(1) A flight performance parameter database 153 containing baseline information relating to the expected values and tolerances of simulator variables. This baseline information is grouped according to different activities, such as procedural activities associated with each phase of flight, and corrective actions such as “climb” or “bank left”.
(2) An experienced gaze database 157 containing experienced gaze information, such as regional dwell times, scan patterns, and other parameters that characterize the visual attention of an experienced pilot. The experienced gaze information is grouped by activity in similar fashion to the flight performance parameter database 153.

Also connected to the local area network 115 is an analysis server 160. The analysis server is configured to execute a software application 165 known herein as the “analysis tool”. The analysis tool 165 analyzes the data received over the network 115 from the computing device 120 and the gaze tracker 140 to generate analysis results for presentation to an instructor 180. The data analysis methods performed by the analysis tool 165 are described in detail below. The analysis tool 165 provides the analysis results over the network 115.

The system 100 also comprises an instructor console 170 and a tablet computing device 175, each configured to be operated by the instructor 180. The instructor console 170 and a tablet computing device 175 are each connected to the local area network 115. The connection between the tablet computing device 175 and the local area network 115 is illustrated in FIG. 1 in dashed form to indicate its preferably wireless nature, although a wired connection is also contemplated. The instructor console 170 and the tablet computing device 175 are each configured to present the audiovisual data received over the network 115 from the computing device 120, the scene camera 145, and/or the data server 150, and to overlay the analysis results received from the analysis tool 165 via the network 115 in the manner described in detail below. The tablet computing device 175 is more suitable for use by the instructor 180 during real-time simulator training, whereas the instructor console 170 is more suitable for debriefing and post-training assessment activities. In an alternative implementation, the system 100 does not include the tablet computing device 175. The instructor console 170 and the tablet computing device 175 are also each configured to provide a user interface through which the instructor 180 can manipulate the presentation of the audiovisual data received over the network 115 from the computing device 120, the scene camera 145, and/or the data server 150 and the analysis results generated by the analysis tool 165. Through the provided interface, the instructor 180 can also control the recording and playback of flight simulator data, gaze scan data, and analysis results to and from the data server 150.

In the system 100 illustrated in FIG. 1, the analysis server 160 is separate from the instructor console 170 and the data server 150. In alternative implementations, two or more of the analysis server 160, the data server 150, and the instructor console 170 are combined within a single computing device.

The system 100 illustrated in FIG. 1 is configured to operate in several modes. In each mode, the flow of data between the elements of the system 100 via the network 115 is different.

The modes of operation are as follows:

Calibration:

The gaze tracker 140 determines a gaze vector by tracking the position of the student's pupil relative to a stationary infrared reflection on the iris contour. Additional calibration is required to reduce the error between the tracker's 140 calculated gaze direction, and the point in which the student's actual gaze direction intercepts with the physical environment, known as the point of gaze intersection. Regions are preconfigured within the gaze tracker's 140 three-dimensional modeling tool as instrument displays, out of cockpit displays, and panels of physical instruments, such as knobs and dials. In one implementation of calibration, the gaze tracker 140 measures two or more gaze direction values, each taken when the student 110 is gazing at corresponding predetermined reference points within each region. The reference points are initially forwarded by the tracker 140 as video data for presentation on the simulator displays, or alternately through the placement of physical markers on panels of instruments. The difference between the measured and expected points of intersection provides error data that is used to extrapolate gaze intersection corrections across each region. Thereafter, in subsequent modes, the gaze tracker 140 provides the real-time gaze intersection point values over the network 115.

Live Test/Record:

The flight simulator audio data and video data (comprising the out-of-cockpit view data and the instrumentation view data) are provided to the instructor console 170 and the tablet computing device 175 for presentation thereon. Meanwhile, the flight simulator data and the gaze scan data are analyzed by the analysis tool 165 in the manner described in detail below. The analysis results generated by the analysis tool 165 are received by the instructor console 170 and the tablet computing device 175 for presentation to the instructor overlaid on the display of the simulator video data in the manner described below. At the same time, the flight simulator data (comprising the audiovisual data and the flight simulator variables) and the gaze scan data are synchronously recorded by the data server 150 for later playback in replay mode. The analysis results generated by the analysis tool 165 are also recorded by the data server 150 for later synchronous playback in replay mode, described below.

Replay:

The flight simulator data, gaze scan data, and analysis results previously recorded by the data server 150 are synchronously played back by the data server 150 under the control of the instructor 180 through an interface on the instructor console 170 or the tablet computing device 175. The played-back flight simulator data, the gaze scan data, and the analysis results are displayed on the instructor console 170 and the tablet computing device 175. In one implementation of replay mode, the played-back flight simulator data, the gaze scan data, and the analysis results are also received and synchronously played back on the computing device 120 for display to the student 110 via the simulator display 130 and the projector 135.

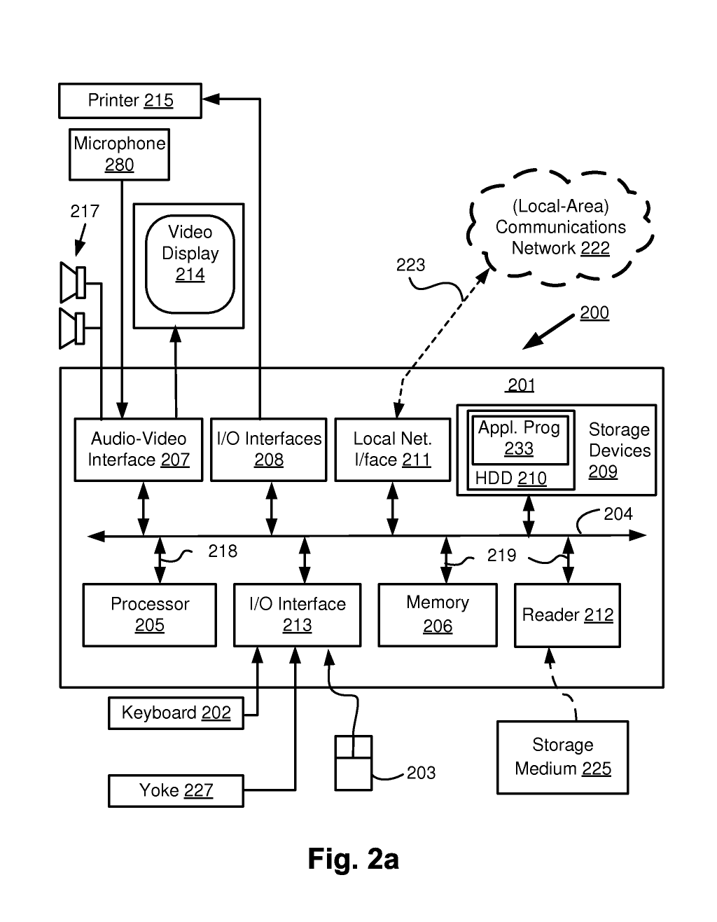

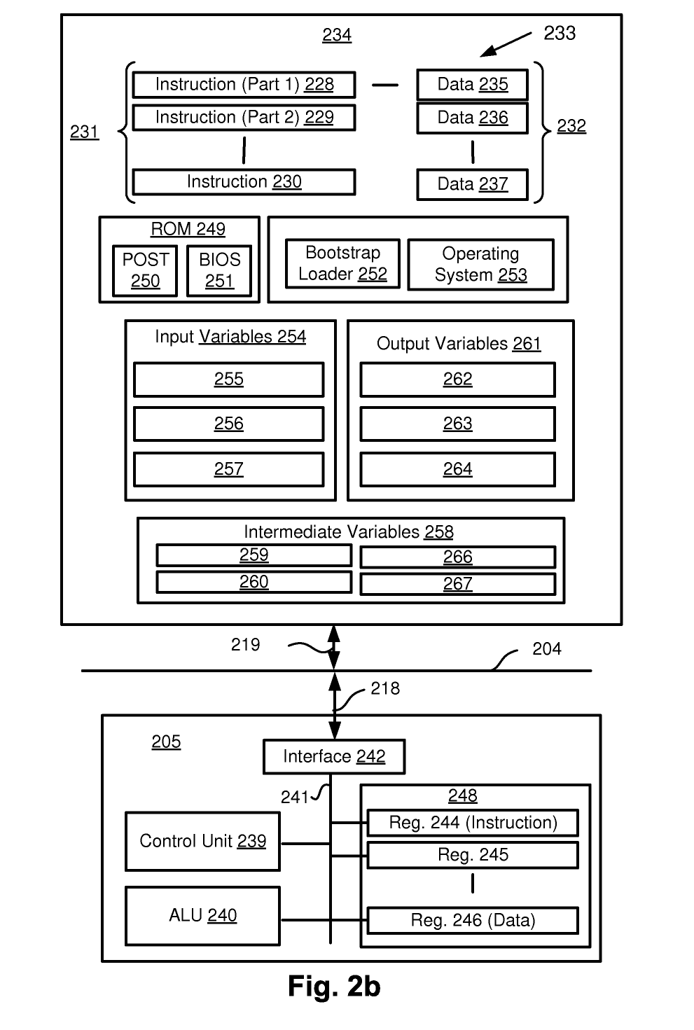

FIG. 2A is a block diagram representing components of a general purpose computer system 200 which can be used to implement the computing device 120, data server 150, analysis server 160, and instructor console 170 depicted in FIG. 1. FIG. 2B is a block diagram showing in further detail the processor and aggregated memory of the computer system depicted FIG. 2A.

As seen in FIG. 2A, the computer system 200 is formed by a computer module 201, input devices such as a keyboard 202, a mouse pointer device 203, a “yoke” 227 configured to control the operation of the flight simulator 125 (for the particular case of the computing device 120), and a microphone 280, and output devices including a printer 215, a display device 214 (in the case of the computing device 120, this can be the display 130 or the projector 135), and loudspeakers 217. Some other input devices configured to control the operation of the flight simulator 125 for the particular case of the computing device 120 include knobs, dials, buttons, switches, throttle controls, pedals, etc. (not shown).

The computer module 201 typically includes at least one processor unit 205 (for the particular case of the computing device 120, multiple processors 205 are more usual), and a memory unit 206 for example formed from semiconductor random access memory (RAM) and semiconductor read only memory (ROM). The module 201 also includes a number of input/output (I/O) interfaces including an audiovisual interface 207 that couples to the video display 214, loudspeakers 217 and microphone 280, an I/O interface 213 for the keyboard 202, mouse 203, yoke 227, and an interface 208 for the printer 215. The computer module 201 also has a local network interface 211 which, via a connection 223, permits coupling of the computer system 200 to a local computer network 222, known as a Local Area Network (LAN), such as the network 115 of FIG. 1. The interface 211 may be formed by an Ethernet™ circuit card, a Bluetooth™ wireless arrangement or an IEEE 802.11 wireless arrangement. The interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. A reader 212 is typically provided to interface with an external non-volatile source of data. A portable computer readable storage device 225, such as optical disks (e.g. CD-ROM, DVD), USB-RAM, and floppy disks for example may then be used as appropriate sources of data to the system 200.

The components 205 to 213 of the computer module 201 typically communicate via an interconnected bus 204 and in a manner which results in a conventional mode of operation of the computer system 200 known to those in the relevant art. Examples of computers on which the described arrangements can be practiced include IBM-PC's and compatibles, Apple Mac or computer systems evolved therefrom.

The analysis methods described hereinafter, as well as the flight simulator 125 (in the case of the computing device 120) and the analysis tool 165 (in the case of the analysis server 160), may be implemented as one or more software application programs 233 executable within the computer system 200. In particular, with reference to FIG. 2B, the steps of the described methods are effected by instructions 231 in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 233 is generally loaded into the computer system 200 from a computer readable medium, and is then typically stored in the HDD 210, as illustrated in FIG. 2A, or the memory 206, after which the software 233 can be executed by the computer system 200. In some instances, the application programs 233 may be supplied to the user encoded on one or more storage media 225 and read via the corresponding reader 212 prior to storage in the memory 210 or 206. Computer readable storage media refers to any non-transitory tangible storage medium that participates in providing instructions and/or data to the computer system 200 for execution and/or processing. Examples of such storage media include floppy disks, magnetic tape, CD-ROM, DVD, a hard disk drive, a ROM or integrated circuit, USB memory, a magneto-optical disk, semiconductor memory, or a computer readable card such as a PCMCIA card and the like, whether or not such devices are internal or external to the computer module 201. A computer readable storage medium having such software or computer program recorded on it is a computer program product. The use of such a computer program product in the computer module 201 effects an apparatus for aircrew training.

Alternatively the software 233 may be read by the computer system 200 from the network 222 or loaded into the computer system 200 from other computer readable media. Examples of transitory or non-tangible computer readable transmission media that may also participate in the provision of software, application programs, instructions and/or data to the computer module 201 include radio or infra-red transmission channels as well as a network connection to another computer or networked device, and the Internet or Intranets including e-mail transmissions and information recorded on websites and the like.

The second part of the application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a block diagram of the processor 205 and a “memory” 234. The memory 234 represents a logical aggregation of all the memory devices (including the HDD 210 and semiconductor memory 206) that can be accessed by the computer module 201 depicted in FIG. 2A.

When the computer module 201 is initially powered up, a power-on self-test (POST) program 250 executes. The POST program 250 is typically stored in a ROM 249 of the semiconductor memory 206. A program permanently stored in a hardware device such as the ROM 249 is sometimes referred to as firmware. The POST program 250 examines hardware within the computer module 201 to ensure proper functioning, and typically checks the processor 205, the memory (209, 206), and a basic input-output systems software (BIOS) module 251, also typically stored in the ROM 249, for correct operation. Once the POST program 250 has run successfully, the BIOS 251 activates the hard disk drive 210. Activation of the hard disk drive 210 causes a bootstrap loader program 252 that is resident on the hard disk drive 210 to execute via the processor 205. This loads an operating system 253 into the RAM memory 206 upon which the operating system 253 commences operation. The operating system 253 is a system level application, executable by the processor 205, to fulfill various high-level functions, including processor management, memory management, device management, storage management, software application interface, and generic user interface.

The operating system 253 manages the memory (209, 206) in order to ensure that each process or application running on the computer module 201 has sufficient memory in which to execute without colliding with memory allocated to another process. Furthermore, the different types of memory available in the system 200 must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

The processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal buses 241 functionally interconnect these functional modules. The processor 205 typically also has one or more interfaces 242 for communicating with external devices via the system bus 204, using a connection 218.

The application program 233 includes a sequence of instructions 231 that may include conditional branch and loop instructions. The program 233 may also include data 232 which is used in execution of the program 233. The instructions 231 and the data 232 are stored in memory locations 228-230 and 235-237 respectively. Depending upon the relative size of the instructions 231 and the memory locations 228-230, a particular instruction may be stored in a single memory location as depicted by the instruction shown in the memory location 230.

Alternatively, an instruction may be segmented into a number of parts each of which is stored in a separate memory location, as depicted by the instruction segments shown in the memory locations 228-229.

In general, the processor 205 is given a set of instructions which are executed therein. The processor 205 then waits for a subsequent input, to which it reacts to by executing another set of instructions. Each input may be provided from one or more of a number of sources, including data generated by one or more of the input devices 202, 203, data received from an external source across the network 222, data retrieved from one of the storage devices 206, 209 or data retrieved from a storage medium 225 inserted into the corresponding reader 212. The execution of a set of the instructions may in some cases result in output of data. Execution may also involve storing data or variables to the memory 234.

The described methods use input variables 254 that are stored in the memory 234 in corresponding memory locations 255-257. The described methods produce output variables 261 that are stored in the memory 234 in corresponding memory locations 262-264. Intermediate variables 258 may be stored in memory locations 259, 260, 266 and 267.

The register section 244-246, the arithmetic logic unit (ALU) 240, and the control unit 239 of the processor 205 work together to perform sequences of micro-operations used to perform “fetch, decode, and execute” cycles for every instruction in the instruction set making up the program 233. Each fetch, decode, and execute cycle comprises:

(a) a fetch operation, which fetches or reads an instruction 231 from a memory location 228;

(b) a decode operation in which the control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location.

Each step or sub-process in the described methods is associated with one or more segments of the program 233, and is performed by the register section 244-247, the ALU 240, and the control unit 239 in the processor 205 working together to perform the fetch, decode, and execute cycles for every instruction in the instruction set for the noted segments of the program 233.

The methods described below may alternatively be implemented in dedicated hardware such as one or more integrated circuits performing the functions or sub functions of the described methods. Such dedicated hardware may include graphic processors, digital signal processors, or one or more microprocessors and associated memories.

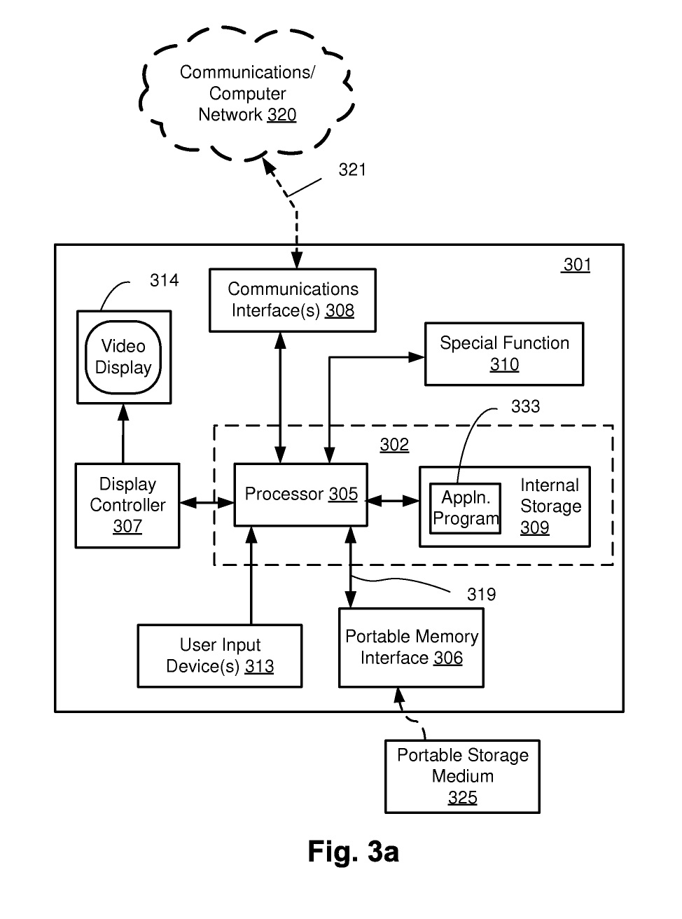

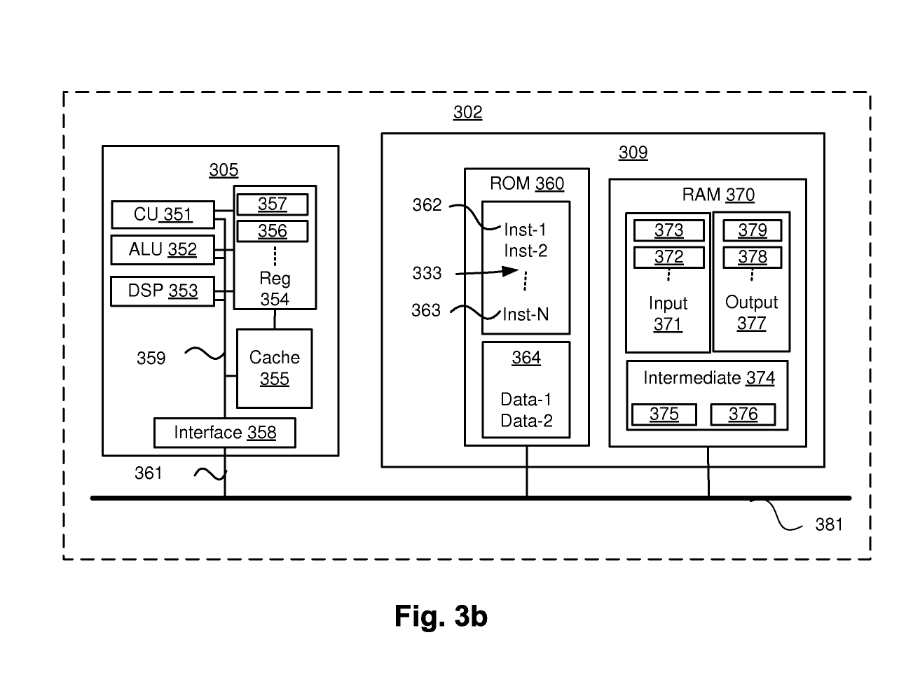

FIG. 3A is a block diagram representation of a general purpose electronic device 301 which can be used to implement the tablet computing device 175 depicted in FIG. 1. FIG. 3B is a block diagram showing in further detail the embedded controller depicted FIG. 3A.

As seen in FIG. 3A, the electronic device 301 comprises an embedded controller 302. Accordingly, the electronic device 301 may be referred to as an “embedded device.” In the present example, the controller 302 has a processing unit (or processor) 305 which is bidirectionally coupled to an internal storage module 309. The storage module 309 may be formed from non-volatile semiconductor read only memory (ROM) 360 and semiconductor random access memory (RAM) 370, as seen in FIG. 3B. The RAM 370 may be volatile, non-volatile or a combination of volatile and non-volatile memory.

The electronic device 301 includes a display controller 307, which is connected to a video display 314, such as a liquid crystal display (LCD) panel or the like. The display controller 307 is configured for displaying graphical images on the video display 314 in accordance with instructions received from the embedded controller 302, to which the display controller 307 is connected.

The electronic device 301 also includes user input devices 313 which are typically formed by keys, a keypad or like controls. In some implementations, the user input devices 313 may include a touch sensitive panel physically associated with the display 314 to collectively form a touch-screen. Such a touch-screen may thus operate as one form of graphical user interface (GUI) as opposed to a prompt- or menu-driven GUI typically used with keypad-display combinations. Other forms of user input device may also be used, such as a microphone (not illustrated) for voice commands or a joystick/thumb wheel (not illustrated) for ease of navigation about menus.

As seen in FIG. 3A, the electronic device 301 also comprises a portable memory interface 306, which is coupled to the processor 305 via a connection 319. The portable memory interface 306 allows a complementary portable computer readable storage medium 325 to be coupled to the electronic device 301 to act as a source or destination of data or to supplement the internal storage module 309. Examples of such interfaces permit coupling with portable computer readable storage media such as Universal Serial Bus (USB) memory devices, Secure Digital (SD) cards, Personal Computer Memory Card International Association (PCMIA) cards, optical disks and magnetic disks.

The electronic device 301 also has a communications interface 308 to permit coupling of the electronic device 301 to a computer or communications network 320, such as the network 115 of FIG. 1, via a connection 321. The connection 321 may be wired or wireless. A wireless connection 321 may be radio frequency or optical. An example of a wired connection 321 includes Ethernet. Further, an example of wireless connection 321 includes Bluetooth™-type local interconnection, Wi-Fi (including protocols based on the standards of the IEEE 802.11 family), Infrared Data Association (IRDA) and the like.

The methods described hereinafter may be implemented using the embedded controller 302, as one or more software application programs 333 executable within the embedded controller 302. In particular, with reference to FIG. 3B, the steps of the described methods are effected by instructions in the software 333 that are carried out within the embedded controller 302. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 333 of the embedded controller 302 is typically stored in the non-volatile ROM 360 of the internal storage module 309. The software 333 stored in the ROM 360 can be updated when required from a computer readable medium. The software 333 can be loaded into and executed by the processor 305. In some instances, the processor 305 may execute software instructions that are located in RAM 370. Software instructions may be loaded into the RAM 370 by the processor 305 initiating a copy of one or more code modules from ROM 360 into RAM 370. Alternatively, the software instructions of one or more code modules may be preinstalled in a non-volatile region of RAM 370 by a manufacturer. After one or more code modules have been located in RAM 370, the processor 305 may execute software instructions of the one or more code modules.

The application program 333 is typically pre-installed and stored in the ROM 360 by a manufacturer, prior to distribution of the electronic device 301. However, in some instances, the application programs 333 may be supplied to the user encoded on the computer readable storage medium 325 and read via the portable memory interface 306 of FIG. 3A prior to storage in the internal storage module 309. Computer readable storage media refers to any non-transitory tangible storage medium that participates in providing instructions and/or data to the embedded controller 302 for execution and/or processing. Examples of such storage media include floppy disks, magnetic tape, CD-ROM, DVD, a hard disk drive, a ROM or integrated circuit, USB memory, a magneto-optical disk, flash memory, or a computer readable card such as a PCMCIA card and the like, whether or not such devices are internal or external of the electronic device 301. A computer readable medium having such software or computer program recorded on it is a computer program product. The use of such a computer program product in the electronic device 301 effects an apparatus for aircrew training.

In another alternative, the software application program 333 may be read by the processor 305 from the network 320, or loaded into the embedded controller 302 from other computer readable media. Examples of transitory or non-tangible computer readable transmission media that may also participate in the provision of software, application programs, instructions and/or data to the electronic device 301 include radio or infra-red transmission channels as well as a network connection to another computer or networked device, and the Internet or Intranets including e-mail transmissions and information recorded on Websites and the like.

The second part of the application programs 333 and the corresponding code modules mentioned above may be executed to implement one or more graphical user interfaces (GUIs) to be rendered or otherwise represented upon the display 314 of FIG. 3A. Through manipulation of the user input device 313 (e.g., the touch screen), a user of the electronic device 301 and the application programs 333 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 3B illustrates in detail the embedded controller 302 having the processor 305 for executing the application programs 333 and the internal storage 309. The internal storage 309 comprises read only memory (ROM) 360 and random access memory (RAM) 370. The processor 305 is able to execute the application programs 333 stored in one or both of the connected memories 360 and 370. When the electronic device 301 is initially powered up, a system program resident in the ROM 360 is executed. The application program 333 permanently stored in the ROM 360 is sometimes referred to as “firmware”. Execution of the firmware by the processor 305 may fulfill various functions, including processor management, memory management, device management, storage management and user interface.

The processor 305 typically includes a number of functional modules including a control unit (CU) 351, an arithmetic logic unit (ALU) 352 and a local or internal memory comprising a set of registers 354 which typically contain atomic data elements 356, 357, along with internal buffer or cache memory 355. One or more internal buses 359 interconnect these functional modules. The processor 305 typically also has one or more interfaces 358 for communicating with external devices via system bus 381, using a connection 361.

The application program 333 includes a sequence of instructions 362 though 363 that may include conditional branch and loop instructions. The program 333 may also include data, which is used in execution of the program 333. This data may be stored as part of the instruction or in a separate location 364 within the ROM 360 or RAM 370.

In general, the processor 305 is given a set of instructions, which are executed therein. This set of instructions may be organized into blocks, which perform specific tasks or handle specific events that occur in the electronic device 301. Typically, the application program 333 waits for events and subsequently executes the block of code associated with that event. Events may be triggered in response to input from a user, via the user input devices 313 of FIG. 3A, as detected by the processor 305. Events may also be triggered in response to other sensors and interfaces in the electronic device 301.

The execution of a set of the instructions may use numeric variables to be read and modified. Such numeric variables are stored in the RAM 370. The disclosed methods use input variables 371 that are stored in known locations 372, 373 in the memory 370. The input variables 371 are processed to produce output variables 377 that are stored in known locations 378, 379 in the memory 370. Intermediate variables 374 may be stored in additional memory locations in locations 375, 376 of the memory 370. Alternatively, some intermediate variables may only exist in the registers 354 of the processor 305.

The execution of a sequence of instructions is achieved in the processor 305 by repeated application of a fetch-execute cycle. The control unit 351 of the processor 305 maintains a register called the program counter, which contains the address in ROM 360 or RAM 370 of the next instruction to be executed. At the start of the fetch execute cycle, the contents of the memory address indexed by the program counter is loaded into the control unit 351. The instruction thus loaded controls the subsequent operation of the processor 305, causing for example, data to be loaded from ROM memory 360 into processor registers 354, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 333, and is performed by repeated execution of a fetch-execute cycle in the processor 305 or similar programmatic operation of other independent processor blocks in the electronic device 301.

In order to draw appropriate conclusions regarding the performance of a student pilot, the context of the student's actions needs to be determined and baseline information regarding visual attention and aircraft state appropriate for that context needs to be retrieved. As mentioned above, the analysis tool 165 executing within the analysis server 160 analyzes real-time data obtained from the simulator 125 and the gaze tracker 140 against baseline information associated with a current context so as to provide the instructor 180 with context-dependent performance results.

The current context is initially determined by the analysis tool 165 from the simulator data, which contains broad indications of the current phase of flight based on the flight time and the simulated flight plan. The current context may be refined by the instructor 180 though real time input via the computer tablet 175 and instructor console 170, or by the analysis tool 165 from the flight simulator variables and/or the student visual attention behavior relative to baseline information associated with the current phase of flight. For example, the current context could be inferred as a procedural activity within the current phase of flight. Alternatively, in response to an unexpected event, the student may have initiated a corrective action that increases visual attention toward instruments that would otherwise be of low priority within the current phase of flight. The corrective action would then be inferred as the current context. In this scenario, the analysis tool 165 would take into account the context of the corrective action rather than a procedural activity that would otherwise be in progress within the current phase of flight.

The analysis tool 165 is configured to evaluate the visual attention behavior of a student both qualitatively and quantitatively by evaluating real-time gaze scan data against the experienced gaze information for the current context obtained from the experienced gaze database 157. Poorly directed visual attention may be characterized as distractions, or associated with poor strategy, such as when students allocate visual attention to regions within the instrumentation view or out-of-cockpit view that are not considered high priority for expected activities in the current phase of flight or for the current corrective action.

A student's situation awareness may be inferred through an evaluation of how effectively they monitor and attend to instruments relevant to the current state of the aircraft. Observing the student perceiving the changing state of instrument variables and consequently adopting an appropriate strategy provides insight into the student's level of information processing. Similarly, certain characteristics of gaze scan data, such as changes in dwell time and scan rate, imply changes in workload for the student.

Further, a Galvanic Skin Response (GSR) sensor may be incorporated into the herein described system. This GSR sensor could be similar to Affectiva's wireless ‘Q Sensor 2.0’ device shown at http://www.affectiva.com/q-sensor/. This GSR device is adapted to measure skin conductance, which is known to correlate with arousal. For example, the GSR device may be in the form of a bracelet or any other suitable device that can be worn by the subject. A wireless stream of the sensors raw data may be recorded into the analysis tool. The fluctuating GSR data is then evaluated within the context of the current student strategy. Changes in arousal can be used to infer levels of associated stress, workload, uncertainty, and other emotional and cognitive aspects of student behavior related with the identified strategy. For instance, if the student is evaluated as having adopting a ‘confused’ strategy, meaning that he is performing illogical or irrelevant activity, elevated GSR readings may be inferred as stress/uncertainty, further supporting a richer characterization of the strategy and performance data. This data may be presented as directional trending information through text, and/or incorporated within other graphical performance flags.

It will be understood that other sensing devices besides GSR may be incorporated into the system, including heart rate and EEG sensors for example, to enhance the data collected and provide more accurate strategy and performance data.

As mentioned above, the results from the analysis tool 165 are presented to the instructor 180 through the instructor console 170 and the tablet computing device 175. The displays of the instructor console 170 and the tablet computing device 175 present the video data from the flight simulator 125, overlaid with the results generated by the analysis tool 165. The overlays are of three kinds:
(a) Gaze scan traces that indicate portions of the recent history of the student gaze intersection point.
(b) Performance flags, comprising text and graphical indicators, that indicate breakdowns, i.e., significant deviations from expected visual attention within the current context.
(c) Performance measurements comprising text and numeric data based on cumulative statistics on flight performance and gaze behavior. The performance measurement data includes the determined operational context.

Strategies adopted by the student are summarized in detail and characterize the objective intent of student activity for the instructor to dismiss or confirm, thereby adding a level of subjective validation to the analysis results generated by the analysis tool 165.

The instructor 180 may, through the interface on the instructor console 170 or the tablet computing device 175, generate time synchronized annotations of the recorded data stream to identify performance breakdowns or instances that may require attention during post training debrief. The annotations are stored synchronously with the simulator data and form part of the played-back data in replay mode.

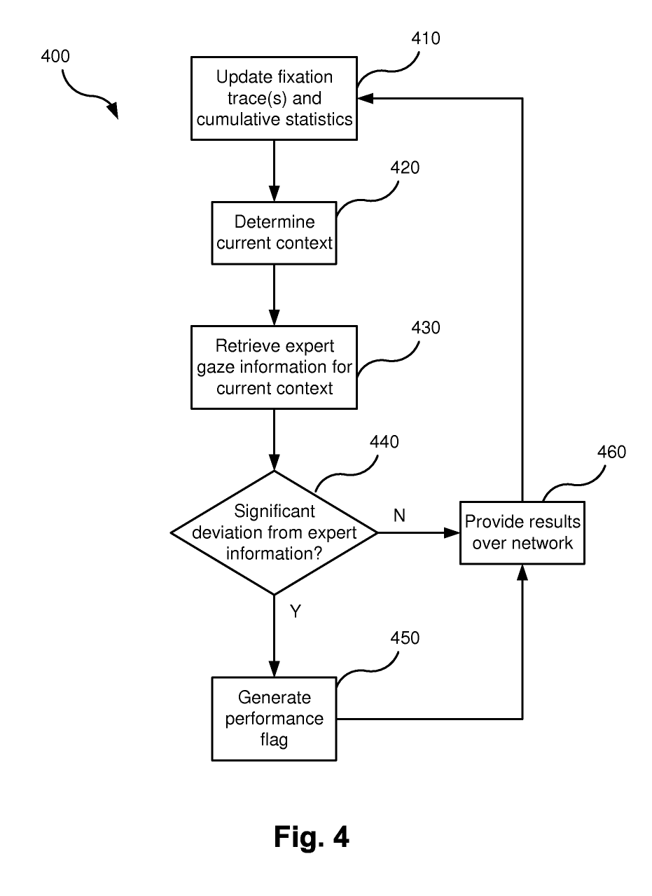

FIG. 4 is a flow diagram illustrating an analysis method 400 carried out by the analysis tool 165 executing within the analysis server 160 of FIG. 1 in accordance with one embodiment. In the implementation of the analysis server 160 as the computer system 200 of FIG. 2a, the analysis method 400 is executed by the processor 205.

The method 400 starts at step 410 on receipt of a gaze intersection value from the network 115, whereupon the analysis tool 165 updates one or more gaze scan traces with the received gaze intersection point. In one implementation, the analysis tool 165 at step 410 also updates the cumulative statistics on flight performance and gaze behavior using the received gaze intersection point and the current simulator variable values extracted from the simulator data.

Step 420 follows, at which the analysis tool 165 determines the current operational context using the current simulator variable values extracted from the simulator data and the recent gaze scan history. The current context includes the procedural activity associated with the current phase of flight or any corrective action currently being undertaken by the student.

At the next step 430, the analysis tool 165 retrieves from the flight performance parameter database 153 and the experienced gaze database 157 the baseline information and the experienced gaze information associated with the current context determined in step 420.

The method 400 then proceeds to step 440, at which the analysis tool 165 determines whether the student's visual attention has deviated significantly from the experienced gaze information associated with the current context. If not, the method 400 at step 460 provides the current context and the analysis results, including the gaze scan trace(s), over the network 115, and returns to step 410 to await the next gaze intersection value from the network 115. If so, the analysis tool 165 at step 450 generates a performance flag indicating the nature of the deviation. The method 400 then at step 460 provides the current context and the analysis results, including the gaze scan trace(s) and the performance flag(s), over the network 115 and returns to step 410.

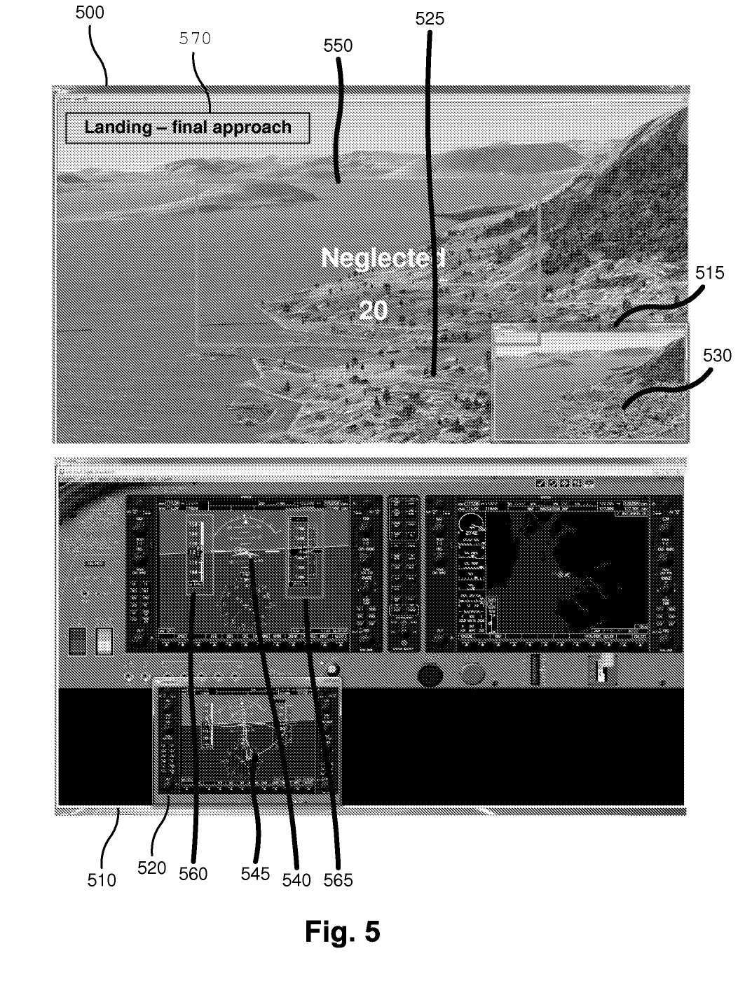

FIG. 5 contains two exemplary screenshots 500, 510 of video data presented to the instructor 180 via the instructor console 170 in the system 100 of FIG. 1 using the method 400 of FIG. 4. The upper screenshot 500 represents one frame of the out-of-cockpit view video data presented at one instant during the “landing” phase of a flight simulator exercise. The current context is the “final approach” procedural activity of the landing phase.

The upper screenshot 500 includes a smaller window 515 showing a grayscale snapshot picture of the out-of-cockpit view video in the main window of the upper screenshot 500. The lower screenshot 510 represents one frame of the instrumentation view video data presented via the display 130 and captured at the same instant during the same flight simulator exercise as the upper screenshot 500. The lower screenshot 510 includes a smaller window 520 showing a grayscale snapshot picture of the instrumentation view video in the main window of the lower screenshot 510.

Overlaid on the main window of the upper screenshot 500 is a gaze scan trace 525 indicating a portion of the recent history of the student's successive points of intersection, that is, the most recent one or two seconds of the gaze scan while it was within the display of the out-of-cockpit view data. Overlaid on the smaller window 515 of the upper screenshot 500 is a gaze scan trace 530 indicating a longer portion of the recent history of the student's gaze scan than that displayed in the main window of the upper screenshot 500. In the implementation shown in FIG. 5, the trace 530 is a static snapshot of the visual scan behavior that occurred during the last period of the student's visual attention to the out-of-cockpit view. The display of the trace 530 is configurable by the instructor.

The lower screenshot 510 is overlaid with a gaze scan trace 540 showing a further portion of the recent history of the student's gaze scan, that is, the most recent one or two seconds of the scan while it was within the display of the instrumentation view data. Overlaid on the smaller window 520 of the lower screenshot 510 is a gaze scan trace 545 indicating a longer portion of the recent history of the student's gaze scan than that displayed in the main window of the lower screenshot 510. In the implementation shown in FIG. 5, the trace 545 is a static snapshot of the visual scan behavior that occurred during the last period of the student's visual attention to the instrumentations view. The display of the trace 545 is configurable by the instructor. In one implementation, the gaze scan traces 525, 530, 540, and 545 are displayed in a green color.

Also overlaid on the upper screenshot 500 is a performance flag, namely a rectangle 550 containing the words “Neglected 20”, indicating that the student's gaze scan has not entered the region indicated by the rectangle for at least 20 seconds, which represents a significant deviation from the experienced gaze behavior associated with the current context. In one implementation, the performance flag 550 is displayed in a red color.

Performance flags, i.e., rectangles 560 and 565, are also overlaid on particular instruments within the lower screenshot 510. The leftmost rectangle 560 indicates that the student's gaze has neglected the underlying instrument compared to the experienced gaze behavior associated with the current context. The rightmost rectangle 565 indicates that the student has overattended to the underlying instrument in relation to the experienced gaze behavior associated with the current context. In one implementation, the “neglect” performance flag 560 is displayed in a red color, while the “overattended” performance flag 565 is displayed in a blue color.

The upper screenshot 500 also contains a text box 570 presenting the current operational context to the instructor 180, to assist the instructor 180 to judge the accuracy and significance of the performance flags 550, 560, and 565. The instructor's interface on the instructor console 170 is configured to allow the instructor to confirm, reject, or correct the current operational context as presented in the text box 570.

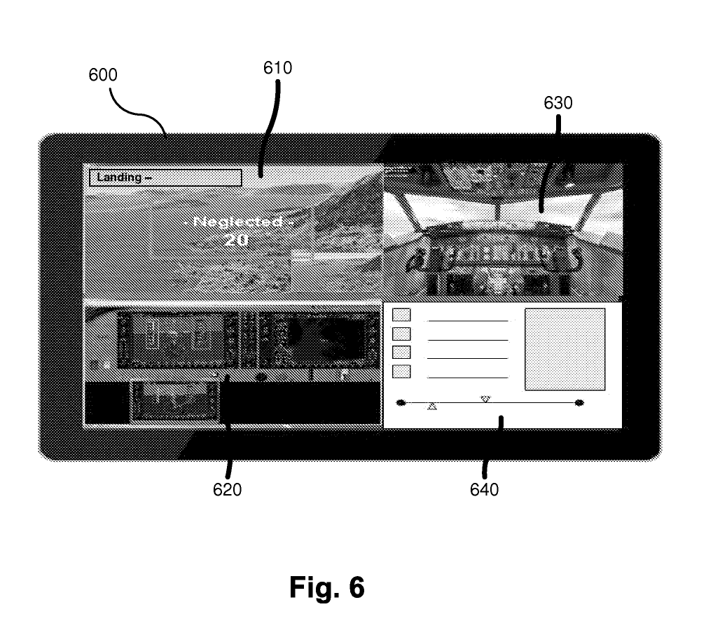

FIG. 6 contains an exemplary screenshot 600 of video data presented to the instructor 180 via the tablet computing device 175 in the system 100 of FIG. 1 using the method 400 of FIG. 4. The screenshot 600 represents the same instant during the same flight simulator exercise as illustrated in the example screenshots of FIG. 5. The upper left quadrant 610 and lower left quadrant 620 of the screenshot 600 are reproductions of the screenshots 500, 510 presented to the instructor 180 via the instructor console 170. The upper right quadrant 630 represents one frame of the scene video data obtained from the scene camera 145. The lower right quadrant 640 contains a graphical interface through which the instructor can control the playback of the simulator data during replay mode, and enter annotations to the simulator data as described above.

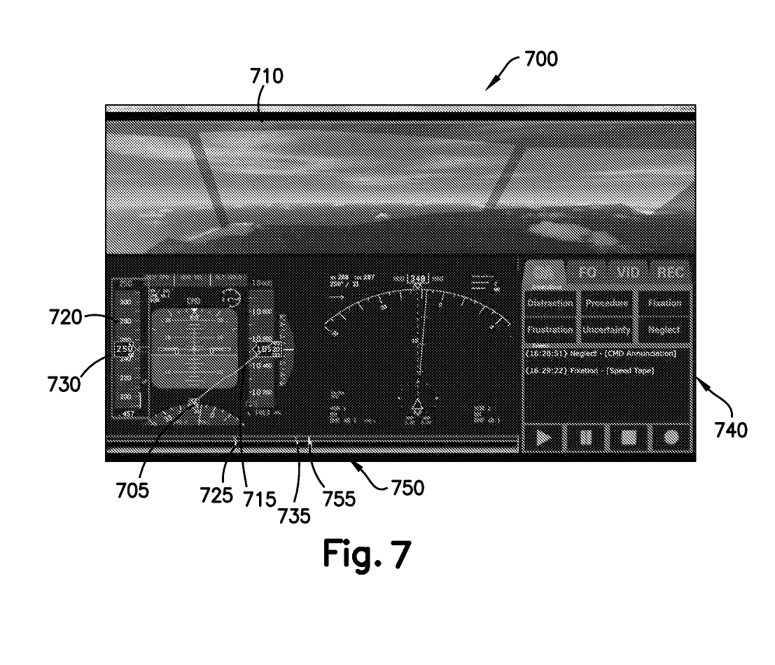

FIG. 7 is an illustrative screenshot 700 of video data presented to the instructor in accordance with an alternative embodiment. The video can run on either the instructor's console or the instructor's tablet computing device. The upper portion 710 of screenshot 700 represents one frame of the out-of-cockpit view video data presented at one instant during the “cruise” phase of a flight simulator exercise. A major portion of the lower portion of screenshot 700 (occupying a middle portion of the lower portion of the screenshot and extending to the left in FIG. 7) represents one frame of the instrumentation view video data captured at the same instant during the same flight simulator exercise as the upper portion of screenshot 700. The instrumentation depicted includes: (a) the primary flight display (comprising a speed tape 720 and other components) on the left; and (b) the navigation display in the middle of the lower portion of screenshot 700.

Overlaid on the primary flight display is a current gaze intersection point indicator in the form of a circle or ellipse 705 and a gaze scan trace 715 indicating a portion of the recent history of the student's gaze scan (i.e., successive points of intersection of the visual gaze). The gaze scan trace 715 starts at the center of the circle or ellipse and trails behind the current gaze intersection point indicator 705 as the latter moves to reflect the location of the tracked gaze intersection point of the student pilot. Although the screenshot of FIG. 7 shows the current gaze intersection point indicator i705 and gaze scan trace 715 overlying the primary flight display, that indicator and trace may be positioned over any portion of the out-of-cockpit view or instrumentation view depending on where the student pilot's gaze intersects the environment at any particular moment during a simulation exercise.

In addition, in this illustration a performance flag, i.e., a rectangle 730, is overlaid on the speed tape 720 to indicate that the student pilot has overattended to, i.e., fixated on, the underlying speed tape in relation to the experienced gaze behavior associated with the current context. The “fixation” performance flag 720 can be displayed in any sufficiently contrasting color. This is one example of the capability of the system to auto-generate a flag through defined logic that determines a fixation or neglect.

Also, a horizontal record stream bar 750 is overlaid on a lower portion of the instrumentation view seen in FIG. 7. The total length of record stream bar 750 may be calibrated to reflect the duration of the flight simulation exercise in progress. An elapsed time indicator 755 moves at constant speed from left to right along the record stream bar 750 to indicate the passage of time from start to finish of the exercise. In addition, each time a performance flag is auto-generated by the system, a corresponding indicator appears on the record stream bar 750. Screenshot 700 shows a Neglect indicator 725 and a Fixation indicator 735 on the record stream bar 750, the relative positions of the indicators along the bar reflecting the fact that an instance of neglect occurred prior to a recent instance of gaze fixation. A Fixation performance flag 730, generated at the same time as the Fixation indicator 735, continues to be displayed at the later time indicated by elapsed time indicator 755.

Returning to the general arrangement of display elements depicted in FIG. 7, a minor portion (i.e., the rightmost portion) of the lower portion of screenshot 700 is occupied by a graphical user interface 740, by means of which the instructor can control the playback of the simulator data during replay mode and can enter time-stamped annotations to the simulator data. In the example shown in FIG. 7, two time-stamped annotations appear in a text field for event logging, which annotations indicate that the student pilot neglected a CMD annunciation at a time 16:28:51 and thereafter fixated his/her gaze on the speed tape (item 720 in FIG. 7) at a time 16:29:22. These time-stamped annotations can be generated by the instructor pressing corresponding preconfigured virtual buttons (see, e.g., the virtual buttons labeled “Neglect” and “Fixation”) which are displayed as part of the graphical user interface 740. Pressing an annotation virtual button time stamps the associated label into the recorded stream. In addition, annotations could be text-based notes input by the instructor using a virtual keyboard (not shown in FIG. 7) on the display screen

The screenshot shown in FIG. 7 is taken from a demonstration video that shows two performance breakdowns during a flight simulation exercise. First, the student visually neglected the CMD annunciation after selecting the auto pilot. In the video (i.e., in screenshots preceding the screenshot shown in FIG. 7), first an amber rectangular border is displayed around the CMD annunciation on the instructor's tablet, then the amber border changes to red when a threshold neglect time has elapsed (Neglect indicator 725 was displayed at the same time), following which a “Neglect—[CMD Annunciation]” annotation automatically appeared in the event log in GUI 740. Second, the student visually fixated on the speed tape 720 for an inordinate length of time, which caused a rectangular border, i.e., Fixation performance flag 730, to appear on the instructor's tablet after a threshold fixation time had elapsed (Fixation indicator 735 was displayed at the same time), following which the “Fixation—[Speed Tape]” annotation automatically appeared in the event log in GUI 740. In this example, the two performance flags were auto-generated based on logic within the analysis tool that evaluates student scan behavior against the current aircraft state and baseline experienced pilot behavior database information.

The annotation buttons 740 may be manually pressed by the instructor when performance breakdowns are observed. Similarly to auto-generated performance flags, this action inserts a performance flag indicator into the record stream bar 750, and logs the appropriate flag as text into the event log in GUI 740.

While aircrew training systems have been described with reference to various embodiments, it will be understood by those skilled in the art that various changes may be made and equivalents may be substituted for elements thereof without departing from the scope of the claims set forth hereinafter. In addition, many modifications may be made to adapt the teachings herein to a particular situation without departing from the scope of the claims.

As used herein, the term “computer system” should be construed broadly to encompass a system having at least one computer or processor, and which may have multiple computers or processors that communicate through a network or bus. As used in the preceding sentence, the terms “computer” and “processor” both refer to devices having a processing unit (e.g., a central processing unit) and some form of memory (i.e., computer-readable medium) for storing a program which is readable by the processing unit.

The method claims set forth hereinafter should not be construed to require that the steps recited therein be performed in alphabetical order (any alphabetical ordering in the claims is used solely for the purpose of referencing previously recited steps) or in the order in which they are recited. Nor should they be construed to exclude any portions of two or more steps being performed concurrently or alternatingly.

1. An aircrew training system comprising:
a computing device hosting a flight simulator configured to be operated by a student and to generate data indicating a current state of the flight simulator;
a gaze tracker configured to generate gaze scan data indicating successive points of intersection of a visual gaze of a student on a display of the computing device; and
an analysis server configured to analyze data from the flight simulator and the gaze scan data, thereby generating results indicating performance of the student for presentation to an instructor.

2. The system as recited in claim 1, wherein the analysis server is further configured to provide analysis results to an instructor console configured to present the data from the flight simulator and the generated results to the instructor.

3. The system as recited in claim 1, wherein the analysis is dependent on a current operational context of the flight simulator.

4. The system as recited in claim 3, wherein the analysis server is further configured to:
determine the current operational context of the flight simulator from the data from the flight simulator and the gaze scan data;
retrieve experienced gaze information associated with the current operational context;
determine whether the gaze scan data has deviated significantly from the experienced gaze information associated with the current operational context; and
generate, depending on the determination, a performance flag indicating a nature of the deviation.

5. The system as recited in claim 1, wherein the analysis server is further configured to update, using the gaze scan data, a gaze scan trace indicating a portion of the recent history of successive points of intersection.

6. The system as recited in claim 1, wherein the analysis server is further configured to update cumulative statistics on flight performance and gaze behavior using the gaze scan data and data from the flight simulator.

7. The system as recited in claim 1, further comprising a data server configured to record to a computer readable storage medium one or more of the group consisting of: the data from the flight simulator, the gaze scan data, and the generated results.

8. The system as recited in claim 7, wherein the data server is further configured to play back recorded data.

9. The system as recited in claim 7, further comprising a scene camera configured to generate audiovisual data including the student and the computing device, wherein the data server is further configured to record the audiovisual data.

10. A method for assessing gaze activity of a flight simulator user, comprising:
(a) acquiring gaze scan data during a flight simulation session, said gaze scan data indicating successive points of intersection of a visual gaze of a user on a display of the flight simulator;
(b) determining a current operational context of the flight simulator;
(c) retrieving experienced gaze data associated with a stored operational context associated with the current operational context;
(d) determining whether or not the gaze scan data differs from the experienced gaze data by more than a threshold; and
(e) generating performance assessment data representing the result of step (d).

11. The method as recited in claim 10, wherein said performance assessment data is transmitted to a display device being viewed by an instructor.

12. The method as recited in claim 11, further comprising presenting video data from the flight simulator overlaid with said performance assessment data in textual and/or graphical form on the display device.

13. The method as recited in claim 10, further comprising recording the acquired gaze scan data and the performance assessment data.

14. The method as recited in claim 11, further comprising updating a gaze scan trace being presented on the display device based on the gaze scan data, wherein the gaze scan trace indicates a history of the points of intersection of the visual gaze of the user.

15. An aircrew training system comprising:
a computer system hosting a flight simulator configured to generate out-of-cockpit view video data, instrumentation view video data and variable data indicating a current state of the flight simulator;
first and second display means for presenting said out-of-cockpit view video data and said instrumentation view video data;
a gaze tracker configured to output gaze scan data indicating successive points of intersection of a visual gaze of a user viewing said first display means; and
an analysis server configured to analyze data from said flight simulator and said gaze scan data to generate performance assessment data, following which said second display means displays textual and/or graphical indicators representing said performance assessment data overlying either out-of-cockpit view video data or instrumentation view video data.

16. The system as recited in claim 15, wherein the analysis performed by said analysis server comprises:
(a) determining a current operational context of the flight simulator;
(b) retrieving experienced gaze data associated with a stored operational context associated with the current operational context;
(c) determining whether or not the gaze scan data differs from the experienced gaze data by more than a threshold.

17. The system as recited in claim 15, wherein the analysis server is further configured to update, using the gaze scan data, a gaze scan trace indicating a portion of recent history of successive points of intersection, said gaze scan trace being displayed on said second display means.

18. An electronic device comprising:
a communications interface configured to receive out-of-cockpit view video data, instrumentation view video data, gaze scan data, and performance deviation data;
a display screen; and
a computer system programmed to control said display screen to display said out-of-cockpit view video data in a first window on said display screen, display said instrumentation view video data in a second window on said display screen, display a current gaze intersection point indicator overlaid on a location within one of said first and second windows specified by said gaze scan data, and display a performance flag overlaid on one of said first and second windows which indicates a nature of a performance deviation specified by said performance deviation data.

19. The electronic device as recited in claim 18, wherein said computer system is further programmed to control said display screen to display a graphical user interface having an event logging field, and also display a time-stamped annotation in said event logging field of said graphical user interface when said performance flag is displayed, said annotation stating the nature of said performance deviation.

20. The electronic device as recited in claim 19, wherein said graphical user interface also has a plurality of virtual buttons, and said computer system is further programmed to log a time-stamped annotation in a record stream in response to a user interaction with one of said virtual buttons.
